(19) United States
(12) Patent Application Publication
(10) Pub. No.: US 2014/0305753 A1
(43) Pub. Date: Oct. 16, 2014

(54) PAD RETRACTION CLIP

(71) Applicant: AKEBONO BRAKE CORPORATION, Farmington, MI (US)

(72) Inventors: Joshua James Macy, Plymouth, MI (US); Philep Jedele, Ypsilanti, MI (US); Eyob Petros Handero, Troy, MI (US); Kenneth Gutelius, Lake Orion, MI (US)

(21) Appl. No.: 13/861,549

(22) Filed: Apr. 12, 2013

(51) Int. Cl. F16D 65/097

(52) U.S. Cl. CPC F16D 65/0979
USPC 188/216

(57) ABSTRACT

A retraction clip comprising: (a) an attachment feature and (b) a retraction feature connected to the attachment feature; wherein the attachment feature attaches the retraction clip to a component of a brake system so that the retraction clip assists in retracting a brake pad after a brake apply.

### FIELD

The present invention generally relates to a clip-on retraction clip for use in a brake system that assists in retracting brake pads after a brake apply.

### BACKGROUND

Typical disc brake systems include a support bracket, one or more brake pads, a caliper, and a rotor. The one or more brake pads are mounted in and located in the support bracket so that the brake pads slide axially towards and away from the rotor. The disc brake system may include a pad clip that attaches to the support bracket and to a portion of the one or more brake pads so that the brake pads are held in the support bracket. The pad clip may cover one or more ears of the brake pad. The disc brake system may include one or more springs that attach to the brake pads to retract the brake pads. The use of one or more clips, one or more springs, or a combination thereof adds additional parts to the braking system and increases the complexity and cost of the brake system. The addition of one or more clips and/or one or more springs may require modifications to be made to the support bracket, brake pads, caliper, or a combination thereof so that the spring and/or clip may be used. Thus, a modification to one or more parts of the support bracket, to the caliper, to the one or more brake pads, or a combination thereof may be required so that a spring and/or a clip may be used with the flake system.

For many years, industry has been concerned with improving the design of braking systems for use with automotive vehicles or other modes of transportation. More recently, reducing fuel consumption has become an increasing concern among vehicle manufacturers and vehicle owners. One cause that affects fuel consumption is brake, drag that is caused by contact forces between the one or more brake pads and the vehicle's rotor. Examples of brake clips and brake springs are disclosed in U.S. Pat. Nos. D483,709S; D489,655; 7,308,974; 7,467,693; and 6,020,674; and U.S. Patent Application Publication 2002/0189911; 2007/0029148; 2007/0251772; 2011/0168503; and 2012/0205205 all of which are expressly incorporated by reference herein for all purposes.

It would be attractive to have a retraction clip (i.e., pad retraction spring) that is discrete and can be added to brake system to improve brake pad retraction. It would be attractive to have a retraction clip that fits within a small packing space and is adapted to securingly connect to existing components of the brake system so that the retraction clip assists in retracting. What is needed is a retraction clip that is made of a single piece of material that can be connected into an existing system without any modifications to the existing system. What is further needed is a discrete retraction clip that can be added aftermarket to a brake system so that the retraction clip assists in retracting the brake pads.

### SUMMARY

One possible embodiment of the present teachings includes: a retraction clip comprising: (a) an attachment feature and (b) a retraction feature connected to the attachment feature; wherein the attachment feature attaches the retraction clip to a component of a brake system so that the retraction clip assists in retracting a brake pad after a brake apply.

Another possible embodiment of the present teachings includes; a brake system comprising: (a) a support bracket having a leading portion and a trailing portion; (b) a pad clip attached to the leading portion of the support bracket; (c) a pad clip attached to the trailing portion of the support bracket; (d) two opposing brake pads extending between the leading side of the support bracket and the trailing side of the support bracket, wherein the two opposing brake pads both contact the pad clip in the leading portion and the pad clip in the trailing portion; and (e) one or more retraction clips comprising: (i) en attachment feature and (ii) a retraction feature connected to the retraction feature; wherein the attachment feature attaches the one or more retraction clips to the leading pad clip, the trailing pad clip, or both so that the one or more retraction clips assist in retracting the two opposing brake pads after a brake apply, and wherein the attachment feature folds back upon itself forming an attachment pocket between the folds for receiving one of the one of more pad clips.

The teachings herein provide a retraction clip (i.e., pad retraction spring) that is discrete and can be added to brake system to improve brake pad retraction. The teachings herein provide a retraction clip that fits within a small packing space and is adapted to securingly connect to existing parts of the brake system so that, the retraction clip assists in retracting. The teachings herein provide a retraction clip that is made of a single piece of material that can be connected into an existing system without any modifications to the existing system. The teachings herein provide a discrete retraction clip that can be added aftermarket to a brake system so that the retraction clip assists in retracting the brake pads.

### BRIEF DESCRIPTION OF THE DRAWINGS

FIG. 1 illustrates a perspective view of a brake system including a retract on clip;

FIG. 2 illustrates a to view of a support bracket including retraction clips;

FIG. 3 illustrates a perspective view of a pad clip having a retraction clip on each side;

FIG. 4 illustrates a top view of FIG. 3;

FIG. 5 illustrates a to perspective view of one possible retraction clip;

FIG. 6 illustrates a bottom perspective view of the retraction clip of FIG. 5:

FIG. 7 illustrates a side view of a brake system including a retraction clip;

FIG. 8 illustrates a perspective view of brake pads having a pad clip and retraction caps on, each side of the pad clip;

FIG. 9 illustrates a perspective view of a pad clip including a retraction clip on each side;

FIG. 10 illustrates a front view of the pad clip of FIG. 9;

FIG. 11 illustrates a front perspective view of one possible retraction clip;

FIG. 12 illustrates a bottom perspective view of the retraction clip of FIG 11;

FIG. 13 illustrates a bottom view of the retraction clip of FIG. 11; and

FIG. 14 illustrated a top view of a retraction clip including reliefs.

### DETAILED DESCRIPTION

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The present teachings provide a brake system. The brake system includes a caliper, a support bracket, and a rotor. The brake system includes an inboard side and an outboard side. For example, the outboard side of the brake system faces out and away from a vehicle and an inboard side faces under and towards a center of the vehicle. In another example, the rotor may form a divider along a center of the brake system and one side of the rotor may be an outboard side and the opposing site may be an inboard side. The brake system includes a trailing region including trailing portion and leading region including a leading portion. The trailing region and the leading region may be designated by the direction of rotation of the rotor. Preferably, the leading region and the trailing region are designated when the direction of rotation of the rotor is in a forward direction. Thus, for example, if a point is located on a rotor and the rotor begins to rotate, the point will first reach a Leading region and they extend past the leading region to the trailing region as the point extends between the brake pads. Thus, every component of the brake system may include a trailing region and a leading region, be located in a trailing region, be located in a leading region, extend between the trailing region and the leading region, be located in an outboard side, be located in an inboard side, extend between the inboard side and the outboard side, or a combination thereof.

One or more pad clips may be installed in the brake system so that the one or, more brake pads contact, slide upon, within, or a combination thereof the one or more pad clips during a brake apply, a brake retract, running, or a condition therebetween. The one or more pad clips may be made of the same material as the clip taught herein. Preferably, the one or more pad clips are made of stainless steel. Preferably, the one or more pad clips may be connected to an abutment of a support bracket. A pad clip may be installed in the trailing region the leading region, or both. The one or more pad dips may extend over the rotor so that a leg of the pad clip is on each side of the rotor and a portion extends over the rotor (i.e., a portion of the pad clip is on the inboard side and a portion is on the outboard side).

The one or more brake pads may connect to the abutment, a pocket created by the abutment, the pad clip, or a combination thereof. The brake pads are installed in the brake system, and the brake pads during a brake apply are moved into contact with the rotor. After a brake apply the brake pads may remain substantially in contact with the rotor. However, after a brake apply, the brake pads may be moved away from the rotor due to disc thickness variation (DTV) of the rotor; wobble of the rotor; decompression of the pressure plate, the friction material, or both of the brake pad; seal groove moving the piston; or a combination thereof. The brake pads may be moved away from the rotor by one or more of the retraction clips taught herein.

The teachings herein provide a retraction clip that is installed in a brake system and when installed assists in creating a retraction force on a brake pad so that the brake pad is retracted. Preferably, each, brake system includes 4 retraction clips that assist in retracting the brake pads (i.e., one in the trailing region and leading region in both the inboard side and the outboard side of the brake system). The retraction clip may have any s and configuration so that the retraction clip attaches to a component of a brake system. The retraction clip may be made of one or more pieces. Preferably, the retraction clip is formed from a single piece of material. The retraction clip may be made from any material configuration (i.e. sheet, roll, coil, block, molten material, liquid material, or the like). The retraction clip may be formed by any process capable of creating a retraction clip with arcuate portions (e.g., deformable portions). The retraction clip may be formed by casting, stamping, cutting, be molding, deep drawing, spinning, press brake forming, roll forming, ironing, wheeling, incremental sheet forming, decambering, or a combination thereof. Preferably, the retraction clip may be made from a metallic sheet, a coil, a roil, or a combination thereof. More preferably, the retraction clip may be stamped from a stainless steel sheet. The retraction clip may be made of any material that assists in retracting a brake pad after a brake apply. Preferably, the retraction clip may be made of metal. The retraction clip may be, made of titanium, aluminum, steel, copper, iron, nickel, cobalt, or a combination thereof. More preferably, the retraction clip may be made of stainless steel. Even more preferably yet, the retraction clip may be made of a material that has a 301 3/4H when measured by ASTM A666 or may be SU301-CSP 3/4H when measured by JIS G4313. Preferably, the retraction clip is made of 301 3/4H stainless steel. The retraction clip may be made of a material that is resistant to corrosion. The retraction clip may be made of any material capable of being formed. The retraction clip may be made of a material that is deformable. The retraction clip may be made of any material that is capable of storing energy, elastically deforming, plastically deforming, or a combination thereof so that the retraction clip moves with the brake pad during a brake apply and assists in creating a refraction force after a brake apply is complete. The retraction clip preferably is elastically deformable so that a portion of the retraction clip moves with the brake pad during a brake apply and the retraction clip assists in moving the brake pad substantially back to the pre brake apply position when the brake apply is complete. The retraction clip may be plastically deformable so that the retraction clip plastically deforms to compensate for the loss of friction material after each brake apply. For example, a brake pad may have friction material with an initial thickness of about 7 mm and after repeated brake applies the material may be worn down to 5 mm and the retraction clip may plastically deform to compensate for the loss of 2 mm of material. The re action clip may include an attachment feature and a retraction feature.

The attachment feature may be any part of the retraction clip that connects the retraction clip to a component. Preferably, the component, may be a pad clip. The attachment feature may be any part of the retraction clip that allows the retraction clip to be installed in a brake system after the brake system is partially constructed, completely constructed, installed in a vehicle, or a combination thereof. The attachment feature may be configured so that one or more brake pads may be installed in the brake system after the retraction clip is installed in the brake system. The attachment feature may securingly connect the retraction clip to component so that the attachment feature creates a secure connection and assists in retracting a brake pad after a brake apply. The attachment feature may create an attachment force on the component.

The attachment force may be a sufficient force so that t e attachment feature remains connected to the component during a brake apply, a brake retract, running, or a condition therebetween. The attachment force on the component may be about 5 N or more, about 8 N or more, or about 10 N or more. The attachment force on the component may be about 30 N or less, about 25 N or less, or about 20 N or less. Preferably, the attachment force on the component is from about 10 N to about 20 N. In addition to the attachment force, the attachment feature may be in tension and/or m compression with a component so that the retraction, clip forms a secure connection with the component. The attachment feature may be configured so that when installed, the brake pad assists in putting the attachment feature in a constant state of compression, tension, or both with the component so that the attachment feature securely connects the retraction clip to the component. The attachment feature and retraction feature may be configured so that the attachment feature and retraction feature work in conjunction with each other to retain the retraction clip in the brake system. For example, the brake pad in a fully retracted position may put the retraction feature in a constant state of tension and/or compression and the retraction feature may translate the tension and/or compressive forces to the attachment feature so that the retraction clip is retained in communication with the component. The retraction feature may move during every brake apply so that the attachment feature is moved into contact with the component and the connection between the component and, the attachment feature re-secured, the component is moved to the end of the attachment pocket, or both. The attachment feature may have any configuration so that the attachment feature securely connects the retraction clip to a component.

The attachment feature may have any shape so that the attachment feature assists in creating a secure connection between the retraction clip and a component. The attachment feature may be any size, shape, configuration, or as combination thereof so that the attachment feature retains the retraction clip in the brake system during a brake apply, a brake retract, running, or a condition therebetween. The attachment feature may be generally shaped, generally “C” shaped, an undulating configuration, fold back upon itself, a clamshell configuration, or a combination thereof. The attachment feature may have a configuration so that the attachment feature forms an attachment pocket for receiving one or more components as discussed herein. For example, the attachment feature may fold back upon itself and this fold may form an attachment pocket for receiving a component. In another example, the attachment feature may include an attachment lock connecting two adjacent attachment arms so that the two adjacent attachment arms form an attachment pocket.

One of the attachment arms may be a clamshell arm that may be folded around an adjacent attachment arm and connected to the adjacent attachment arm by an attachment lock so that an attachment pocket is formed therebetween. The attachment lock may be a hinge connecting two adjacent attachment arms (e.g., clamshell arm may be connected to and rotated about a static attachment arm into a position so that the clamshell arm forms substantially a mirror shape to the attachment arm). The attachment lock may connect two adjacent arms and assist in creating an attachment force. The attachment look may be elastically deformable so that a component may be pressed into the, attachment pocket and substantially retained in place. The attachment feature may be configured so that the attachment feature has an increased surface area when compared to the retraction feature, the rest of the retraction clip, or both.

The attachment feature may have a width that is larger than the width of the retraction feature. The width of the attachment feature may be sufficiently wide so that the attachment feature grips a component and secures the retraction clip to the component. The width of the attachment feature may be sufficiently large so that an increase in surface area of the attachment feature secures the retraction clip to a component. The width of the attachment feature may be about 2 mm or more, about 4 mm or more, or preferably about 6 mm or more. The width of the attachment feature may be about 15 mm or less, about 12 mm or less, about 10 mm or less, or about 8 mm or less. The width of the attachment feature may be sufficiently large so that the attachment feature includes a factor of safety, limits deformation to the retraction arms, or both. The width of the attachment feature may be Y and the width of the retraction feature may be X. Preferably, the width of the attachment feature is greater than the width of the retraction feature. Y may be equal to about 1.5× or more, about 1.7× or more, or about 2× or more. Y may be about 5× or less, about 3× or, less, or about 2.5× or less. The width of the attachment feature may gradually taper from the width of the retraction feature. The width as discussed herein for the attachment feature and the retraction feature may be the non-tapered widths. For example, the width as discussed herein may be measured in a region that is not part of the connection region between the attachment feature and the retraction feature. The attachment feature may be comprised of one or more components that work in conjunction with each other to form a secure connection with a component of the brake system.

The attachment feature may include a region that all or a portion of a component may be inserted. Preferably, the attachment feature includes an attachment pocket that a portion of the component, the pad clip, or both may be inserted so that the attachment pocket grips the component; produces an attachment force as discussed herein on one or both sides of the component or both. The attachment pocket may have one or more deformable portions as discussed herein. Preferably, an end of the pocket forms a deformable portion that assists in producing the attachment force discussed herein. The attachment pocket may include one or more locking features that assist in connecting the retraction clip to the component. For example, the locking feature may be an adhesive, a mechanical fastener, a pin, a detent, or a combination thereof that assist in retaining the retraction clip in contact with the component. The locking feature may be any feature that increases and attachment force on a component when compared to a holder that does not include the attachment feature. The locking feature may be any feature that places one or both of the attachment arms in tension so that an attachment force is created. Preferably, the attachment pocket, the attachment feature, or both may be free of any locking features that assist in connecting the retraction clip to a component. The attachment pocket may have a depth.

The depth of the attachment pocket may be sufficiently deep so that the attachment pocket assists in forming a secure connection with the component, the component does not come out of the attachment pocket, the retraction clip does not rotate around the attachment pocket, or a combination thereof. The depth of the attachment pocket may be about 1.5 mm or more, preferably about 2.0 mm or more, more preferably about 2.5 mm or more, or more preferably about 3 mm or more. The depth of the attachment pocket may be about 10 mm or less, about 7 mm or less, or about 5.0 mm or less. The depth of the attachment pocket may be directly proportional to the width of the attachment feature. For example, the wider the attachment feature the deeper the pocket. The depth of the attachment pocket may be inversely proportional to the width of the attachment feature. For example, a desired surface area of the pocket may be maintained by making the width less when the pocket is deeper or vice versa. The attachment pocket may have one or more projections on either side of the attachment pocket.

The projections may be any part of the attachment feature that extends away from the attachment pocket. The projections may be an undulating portion, a curved portion, a fold, an arm, or a combination thereof. Preferably, at least one of the projections is an attachment arm. The attachment arm may be any feature that assists in forming a secure connection with a component. The attachment arm may assist in creating an attachment force as discussed herein. The attachment arm may be elastically deformable so that a component may be placed in the attachment pocket. The attachment arm may create an attachment force on one side of the component and this attachment force may move the component so that an opposing side of the pocket creates an opposing attachment force on an opposing side of the component. The attachment arm and an arm opposing the attachment arm may create a clamping force so that a component, a retraction clip, or both are connected. The attachment arm may have a cantilever connection with the attachment pocket so that a free end of the attachment arm creates an attachment force on the component. One or more of the attachment arms may be a clamshell arm. The attachment pocket may act as a spring preventing the attachment arm from moving away from the component so that an attachment force is created on the component. The attachment arm may include one or more attachment features that assist in connecting the retraction clip to the component.

The attachment features may be a rib, a step, an angled piece, or a combination thereof. The attachment feature may be a unidirectional device. For example, the unidirectional device may allow a component to extend proximate to the attachment arm, into the attachment pocket, or both and prevent the component from being moved in a direction that opposes attachment direction. Preferably, the attachment feature is located outside of the attachment pocket. More preferably, the attachment feature is located proximate to, an end of the attachment arm so that the attachment force moves the attachment feature into contact with the component. The attachment feature may prevent movement of the retraction clip when the retraction feature is retracting a brake pad a brake pad is moving the retraction feature, during running, or a time therebetween.

The retraction feature may be any part of the retraction clip that assists in moving a brake pad in the retract direction. The retraction feature may be any part of the retraction dip that generates a retraction force. The retraction feature may be any size and shape so that the retraction feature generates a sufficient force to assist in retracting a brake pad after a brake apply. The retraction feature may have any configuration so that the retraction feature generates a sufficient force to move the brake pad to substantially a pre-brake apply position. The retraction feature of each of one or more retraction dips may exert an axial force, relate to the rotor, in the retract direction of about 5 N More, about or more, about 15 N or more, about 20 N or more, about 25 N of more, or about 30 N or more. The retraction feature of each of the one or more retraction cops may exert an axial force, relative to the rotor, in the retract direction of about 50 N or less, about 45 N or less, or about 40 N or less. The force exerted by the retraction feature may generated by one or more deformable portions.

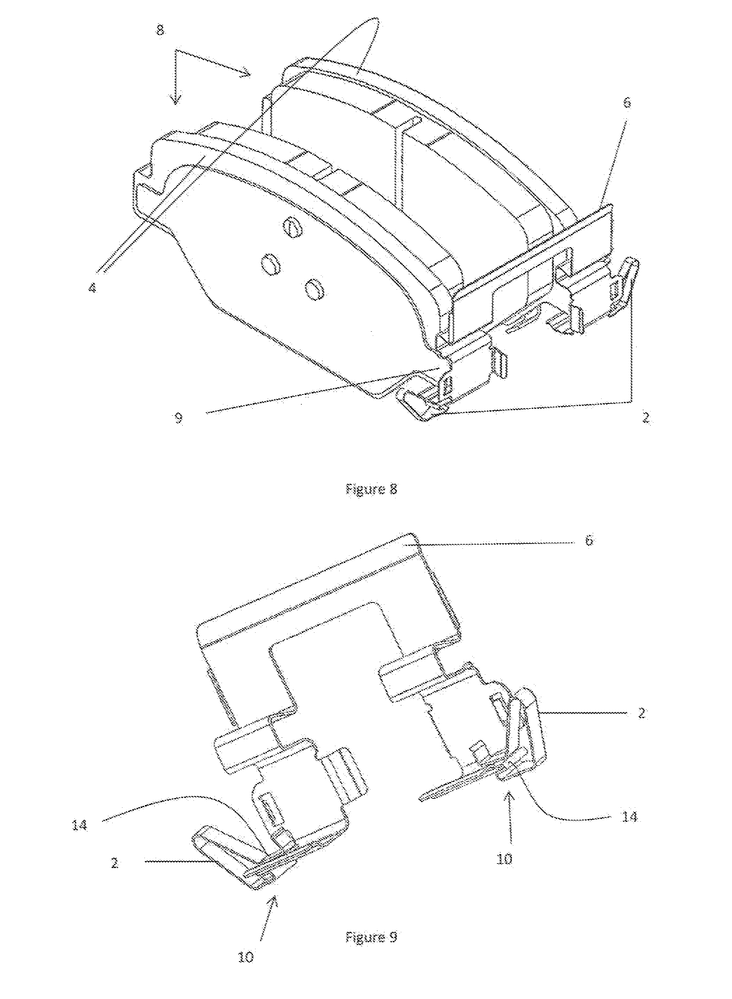

The retraction feature may include one or more deformable portions, one or more cross-over cutouts, or both. Preferably, the retraction may include a plurality of deformable portions. The deformable portions of the retraction feature may be any part of the retraction feature that stores energy during a brake apply so that stored energy can be released to facilitate retracting the brake pads. The deformable portions of the retraction arm may form a spring-like region that allows the retraction feature to stretch during a brake apply and compress during a brake release or vice versa. The deformable portions may be a bend, curve, angled portion, arcuate portion, an overlapping portion, a undulating portion, a “U” shape, an “S” shape, a “C” shape, or a combination thereof that change shape during a brake apply. The deformable portions may be elastically deformable, plastically deformable, or both. Preferably, the deformable portions are substantially free of plastic deformation. The deformable portions may be shaped so that the retraction feature includes a segment that is, generally “S” shaped, includes one or more portions that generally fold back and forth, includes one or more “U” shaped segments, or a combination thereof. Each retraction feature may include two or more generally “U” shaped portions, and preferably at least 3 generally “U” shaped portions. A portion of the retraction features may extend under and/or over another portion of the retraction feature (i.e., a cross-over cutout). For example, a portion of the retraction feature may extend under another portion of a retraction feature similar to that of a “FIG. 8.” One or both the portions may be thinner (e.g., a first cross-over portion, a second crossover portion, or both) in the regions where the overlap is formed (i.e., where one extends under the other).

The one or more cross-over cutouts may be any portion so that an attachment arm extends past, through, along, under, over, or a combination thereof the retraction feature. The one or more cross-over cutouts may include a first cross-over portion, a second cross-over portion, a first gap, a second gap, or a combination thereof. The first cross-over portion, the cord cross-over portion, or both may extend from an edge towards a central region and stop short of the opposing edge so that a gap is formed. The first cross-over portion, the second cross-over portion, or both may extend from opposing edges. For example, the first cross-over portion may extend from a first edge towards a central region and the second cross-over portion may extend from a second edge towards the central region. The first cross-over portion and the second cross-over portion may be connected by a connection portion. The connection portion may extend from a first edge to a second edge and have a central region therebetween. The connection portion may connect the first cross-over portion to the second cross-over portion so that a gap is formed proximate to each of the first cross-over portion and the second cross-over portion. The width of the connection portion is greater than both the first cross-over connection and the second cross-over connection. The width of the first cross-over connection and the second cross-over connection may be substantially the same. The width of the first cross-over connection plus the width of the second cross-over connection may be equal to the width of the connection portion. The width of the connection portion may be C and the width of the first cross-over connection and the second cross-over connection may be 1/4C or more, 1/3C or more, or 1/2C or more. The width of the connection portion may be C and the width of the first cross-over connection and the second cross-over connection may be 9/10C or less, 4/5C or less, or about 3/4C or less so that a sufficiently large gap is formed for the retraction arm to extend through. The width of the gap adjacent to the first cross-over connection and the second cross-over connection may be substantially equal to the width of the attachment arm so that the attachment arm may contact one of the first cross-over connection or the second ross-over connection and remain aligned, not extend past a largest width of the retraction clip, or both. The first cross-over connection, the second cross-over connection, or both may be tapered on one or both ends. The first cross-over connection, the second cross-over connection, or both may be located proximate to a deformable portion, be a deformable portion, or both. The deformable portions may form any angle so that the retraction features extend during a brake apply and assists in retracting during a brake release.

The deformable portions may include one or more angled portions. The one or more angled portions may be configured so that the retraction clip may be connected to a component and a brake pad added and removed from the brake system. The one or more angled portions may have a sufficient angle so that a brake pad may be added, removed, or both to the brake system without removing the retraction clip from the brake system. Preferably, the deformable portion includes a plurality of angled portions. More preferably, the deformable, portion includes 3 or more, 4 or more, or even 5 or more angled portions. The angles may each vary. For example, one angle may be 90 degrees and one angle may be 180 degrees. Preferably, each retraction feature includes an angled portion that has an angle of about 180 degrees or more, preferably about 205 degrees or more, or about 250 degrees or more lit about 270 degrees). The retraction feature may have an angled portion that has an angle that angles at least a portion of the retraction clip away from the brake pad along an axis defined by the direction of retraction. The retraction feature may include an angle is about 85 degrees or more, preferably abbot 90 degrees or more, more preferably about 100 degrees or more, or more preferably about 105 degrees or more about 115 degrees). The degree of the angle of the deformable, portions may affect the amount of retraction force generated by the retraction feature. The deformable portions may include one or more reliefs.

The one or more reliefs may be any part of the deformable portion that adjusts the amount of force required to move the deformable portion, amount of force the deformable portion exhibits in the retract direction, the plastic deformability of the deformable portion, or a combination thereof. The one or more reliefs may be an absence of material, a thinning of the material, a thickening of material, a decrease in width, an increase in width, a cut in the material, a slit in the material, or a combination thereof. The one or more reliefs may assist in making one region more elastically deformable so that the region, performs a majority of the deforming. The one or more reliefs may extend parallel to the direction of retraction, perpendicular to the direction of retraction, or any angle therebetween. Preferably, at least a portion of the retraction feature is free of deformable portions, reliefs, or both.

The retraction feature may have at least one linear segment. The linear segment may be any portion that extends up to the brake pad. The linear segment may extend under the brake pad. The linear segment may be parallel to the direction of retraction. Preferably, the linear segment extends under the brake pad and includes a lip that contacts the brake pad so that the brake pad and retraction clip move together during a brake apply, a brake retract, running, or a condition therebetween.

The lip may be any part of the retraction feature that contacts the brake pad so that during a brake release the lip assists in moving the brake pad in the direction of retraction. The lip may extend at an angle relative to the linear portion. Preferably the lip forms an angle with the linear portion of about 80 degrees or greater, about 85 degrees or greater, or about 90 degrees.

FIG. 1 illustrates a brake assembly 50 including a retraction clip 2. The brake assembly 50 includes a caliper 52 and a support bracket 54. The support bracket 54 includes a pair of brake pads 8 with a pad clip 6 and a retraction clip 2. The retraction clip 2 is located above an ear 9 of the brake pad 6 and in contact with the pressure plate 4 so that when a brake apply is complete the retraction clips 2 assist in moving the brake pads 8.

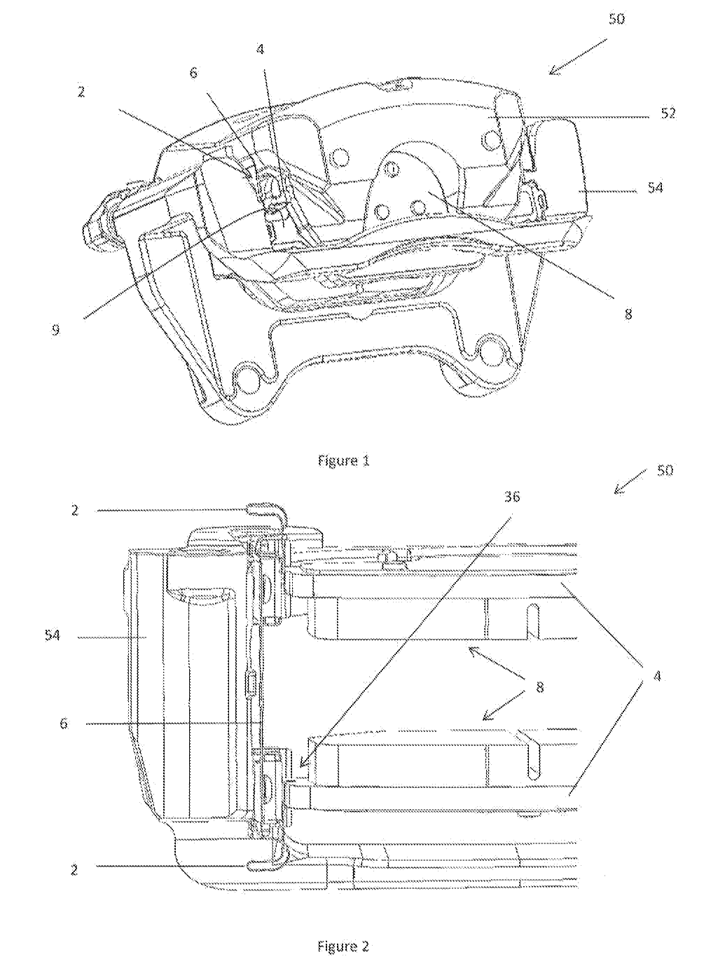

FIG. 2 illustrates a top view of one embodiment of the retraction clips 2 installed in the brake assembly 50 with the caliper removed. The support bracket 54 includes a pad clip 6 with a retraction clip 2 extending from each side. A lip 36 of each retraction clip 2 contacts the pressure plate 4 of each respective brake pad 8 so that after a brake apply the retraction clip 2 assists in moving each brake pad 8 substantially back to a pre-brake apply position.

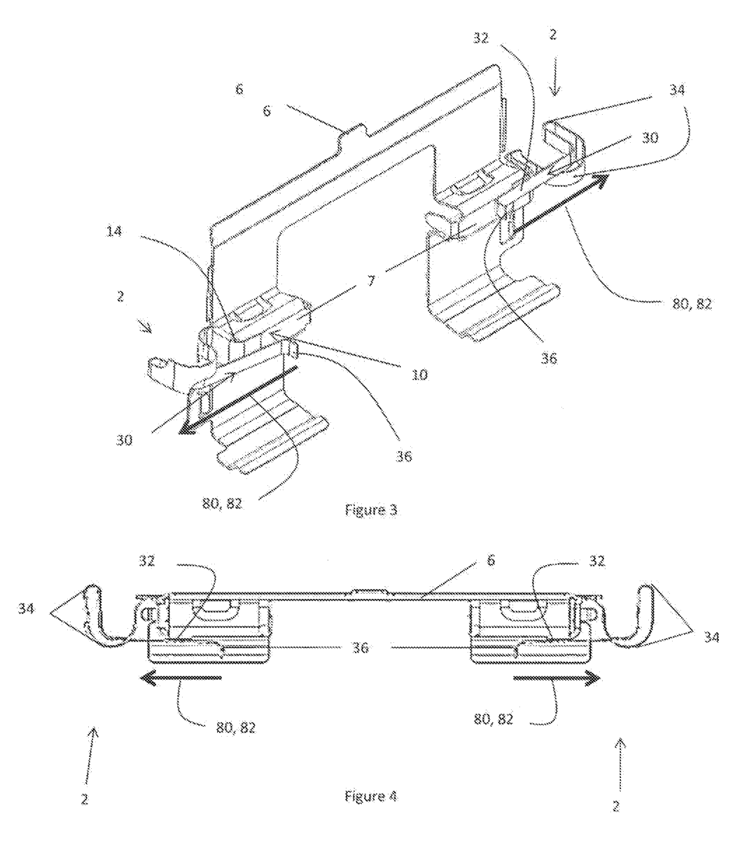

FIG. 3 illustrates a perspective view of one example of a retraction clip 2 of the teachings herein one each side of a pad clip 6. The retraction clips 2 are connected to the angled bracket 7 of the pad clips 6 by an attachment feature 10. The attachment feature 10 includes an attachment pocket 14 that receives the pad clip 6 so that a connection is formed between the retraction clip 2 and the pad clip 6. The retraction clip 2 includes a retraction feature 30 including a retraction arm 32 with a lip 36. During a brake apply the brake pads (not shown) are moved and the deformable portions 34 are deformed so that energy is stored in the deformable portions 34. When the brake apply is complete the retraction arms 32 apply a retraction force 80 in the direction 82 so that the retraction clips 2 assist in returning the brake pads (not shown) substantially to a pre-brake apply position.

FIG. 4 illustrates a top view of a pad clip 6 with retraction clips 2 extending from each side. Each retraction,dip 2 includes multiple deformable portions 34 that store energy during, a brake apply so that when a brake apply is complete deformable portions 34 move the lip 36 of the retraction arm 32 in the direction 82 and produce a retraction force 80.

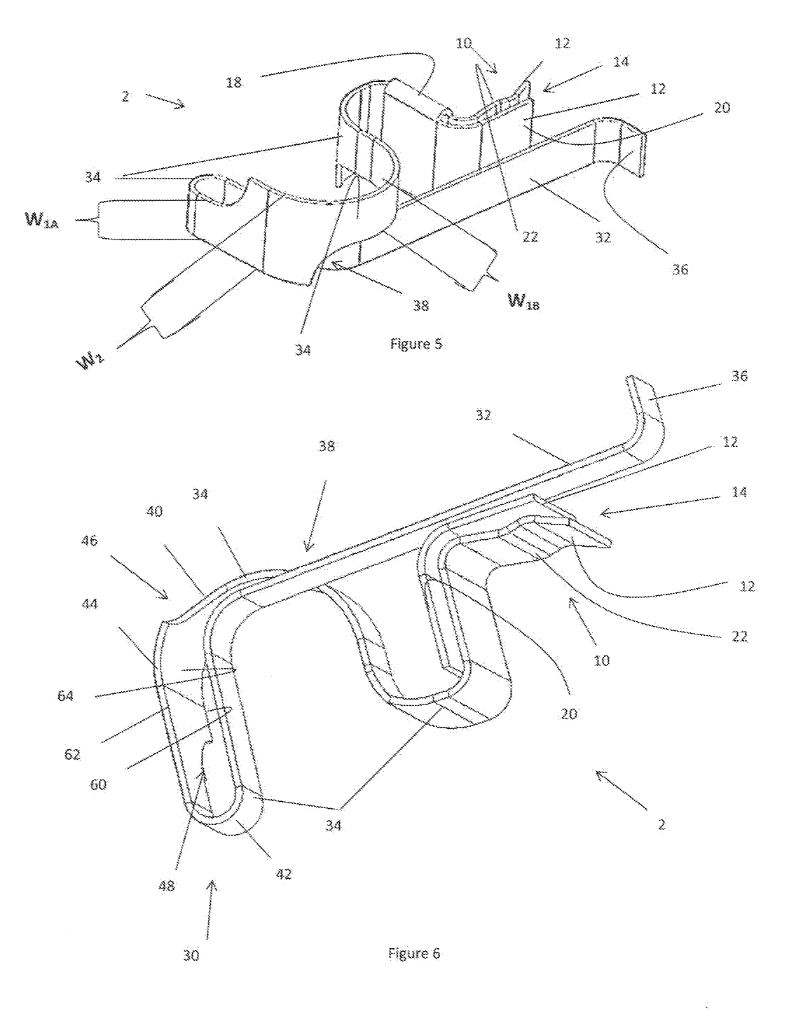

FIG. 5 illustrates a top perspective view of a retraction clip 2. The retraction clip includes an attachment feature 10 for attaching the retraction feature to an adjacent component (not shown). The attachment feature 10 includes two attachment arms 12. A first attachment arm 12 opposes a second attachment arm 12 that is a clam shell arm 20 that is connected to the first attachment arm 12 by an attachment lock 18 that spans between the two attachment arms 12. An attachment pocket 14 is formed between the two attachment arms 12. As illustrated, the first attachment arm 12 includes a detent 22 that assists in producing a gripping force on the adjacent component (not shown). A plurality of deformable portions 34 extend from the attachment feature 10. The deformable portions 34 are connected to a retraction arm 32. One of the deformable portions 34 include a cross-over cut out 38 so that the retraction arm 32 extends under a deformable potion 34 or a part of the retraction clip 2 adjacent to a deformation portion 34. The deformable portion 34 has a cross-over width (W_{1A}) on a first side and a cross-over width (W_{1B}) on a second side that are connected by a second width (W₂) so that a cross-over cut out is formed. The dimensions of the widths may be vaned so that the amount of retraction force applied to the lip 36 during a retraction may be varied.

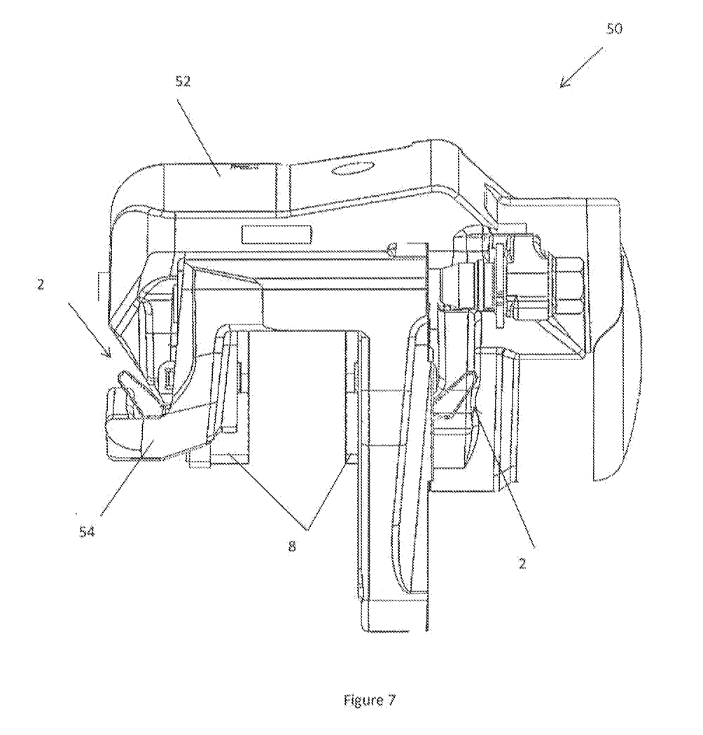

FIG. 6 illustrates a bottom perspective view of the retraction clip 2 of FIG. 5. The retraction clip 2 includes a retraction arm 32 including a lip 36. A cross-over portion 40 is formed in the retraction feature 30. The cross over cutout 38 includes a first cross-over portion 40 and a gap 46 formed adjacent to the first cross-over portion 40 so that the retraction arm 32 extends through the cross-over cutout 38. The cross-over cutout 38 includes a connection portion 44 that is located between a first cross-over portion 40 and second cross-over portion 42. The connection portion 44 has a width (W2); the first cross-over portion 40 has a width (W1B); and the second cross-over portion 42 has a width (W1A) as shown in FIG. 5. The width of the first cross-over portion 40 is less than the width of the connection portion 44 so that a gap 46 is formed adjacent to the first cross-over portion 46. The width of the second cross-over portion 42 is less than the width of the connection portion 44 so that a second gap 48 is formed adjacent to the second cross-over portion 42. Additionally, the first cross-over portion 40 connects to and extends from a first edge 60 of the retraction feature 30 towards a central region 64, but is free of contact with a second edge 62, and the second cross-over portion 42 connects to and extends from a second edge 62 towards a central region 64, but is free of contact with the first edge 60. The deformable portions 34 assist in retraction the retraction arm 32 after a brake apply is complete. An attachment feature 10 is located underneath the retraction arm 32. The attachment feature 10 includes two opposing attachment arms 12 that form an attachment pocket 14 for receiving an adjacent component (not shown). One of the attachment arms 12 is formed by being folded behind the other attachment arm 12 so that the folded arm is a clamshell arm 20. The non folded attachment arm 12 includes a detent 22.

FIG. 7 illustrates a brake assembly 50. The brake assembly 20 includes a caliper 52, a support bracket 54, and two opposing brake pads 8. A retraction clip 2 is located proximate to and in contact with each brake pad 8.

FIG. 68illustrates two brake pads 8 in contact with a pad clip 6. The brake pads 8 include a pressure plate 4 and have an ear 9 that extends into the pad clip 6. A retraction clip 2 is located on each side of the pad clip 6 and in contact with each respective ear 9 of the brake pad 8.

FIG. 9 illustrates a perspective view of a pad clip 6 including a pair of retraction clips 2. Each of the retraction clips 2 include an attachment feature 10 having an attachment pocket 14 for receiving a portion of the pad clip 6 so that the retraction clips 2 and the pad clip 6 are connected.

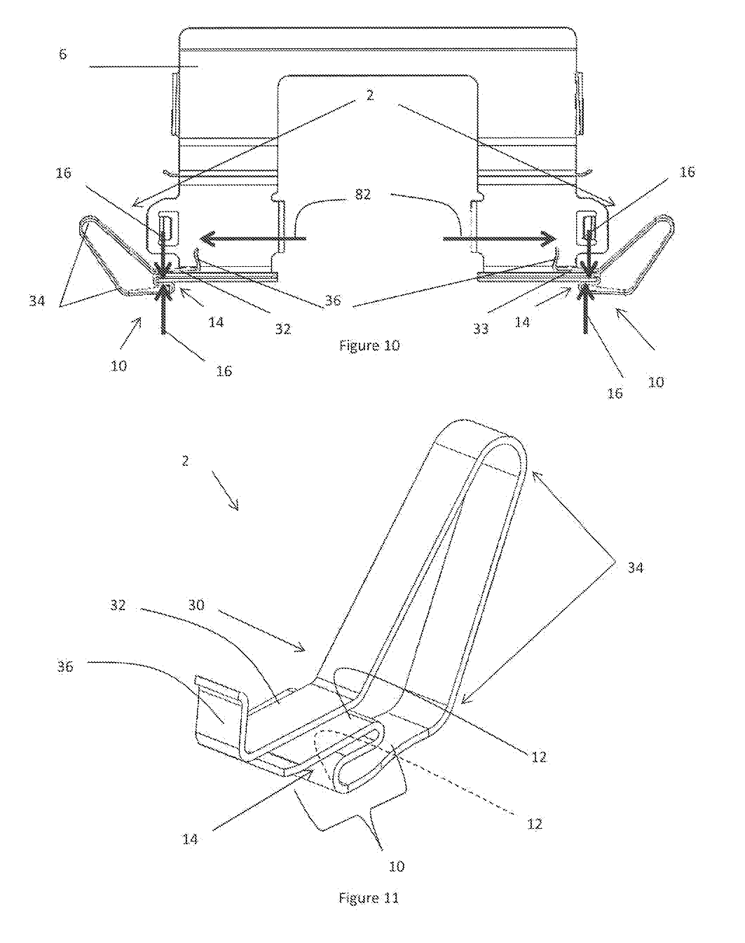

FIG. 10 illustrates a front perspective view of FIG. 9. A pad clip includes a retraction clip 2 on each side. Each retraction clip includes an attachment feature 10 including an attachment pocket 14 that produces an attachment force 16 for, securing the retraction clips 2 to the pad clip 6. During, a brake apply the brake pads (not shown) contact the lip 36 of the retraction arms 32 and move the retraction arms 32 so that the deformable portions 34 deform. When a brake apply is complete the deformable portions 34 move the retraction arms 32 and lip 36 in the direction 82 to assist in retracting the brake pads not shown).

FIG. 11 illustrates a front perspective view of a retraction clip 2. The retraction clip 2 includes a retraction feature 30 having a lip 36 and a retraction arm 32. The retraction feature 30 includes deformable portions 34. The retraction feature 30 is connected to an attachment feature 10. The attachment feature 10 includes attachment arms 12 that are folded to be adjacent to one another and forming an attachment pocket 14 therebetween.

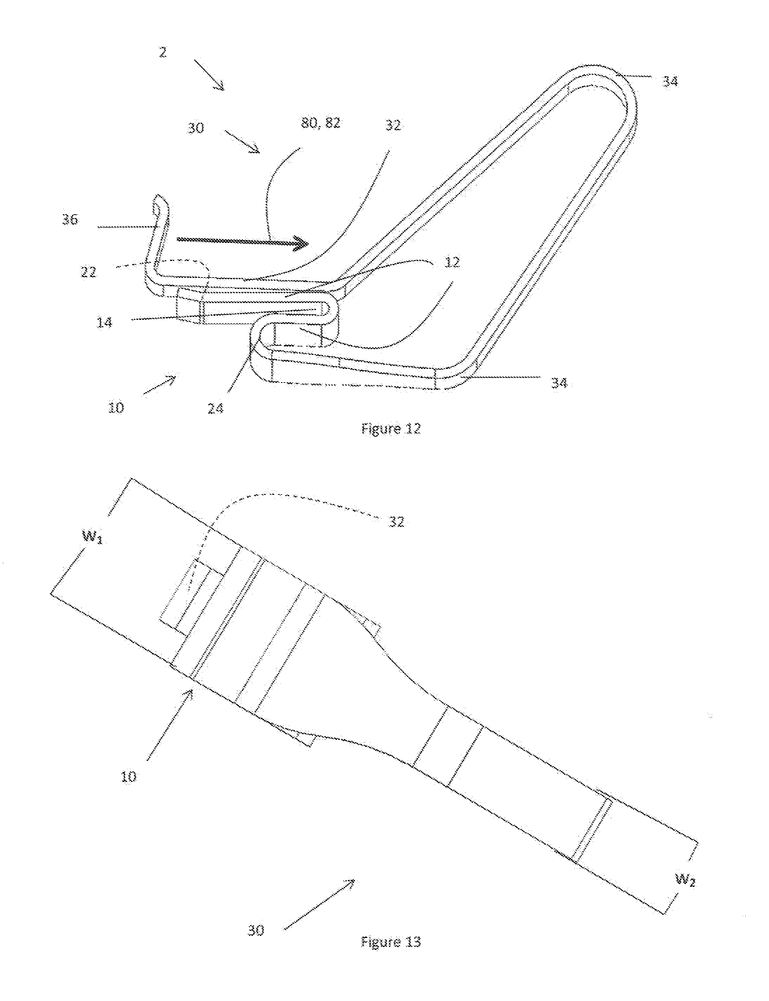

FIG. 12 is a bottom perspective view of the retraction clip 2. The retraction clip 2 has a retraction feature 30 with a lip 36, retraction arm 32, and deformable portions 34. The deformable portions apply a retraction force 80 in the direction 82 so that the lip 36 contacts and moves a brake pad (not shown). The deformable portions 34 extend to an attachment feature 10 having attachment arms 12 that fold back upon themselves forming a projection 24 and an attachment pocket 14.

FIG. 13 illustrates a bottom view of the retraction clip 2. The retraction clip 2 includes an attachment feature 10 and a retraction feature 30 having a refraction arm 32 that extends past the attachment feature 10. The attachment feature having a width (W₁) and the retraction feature 30 having a width (W₂) that is greater than the width (W₁) of the attachment feature.

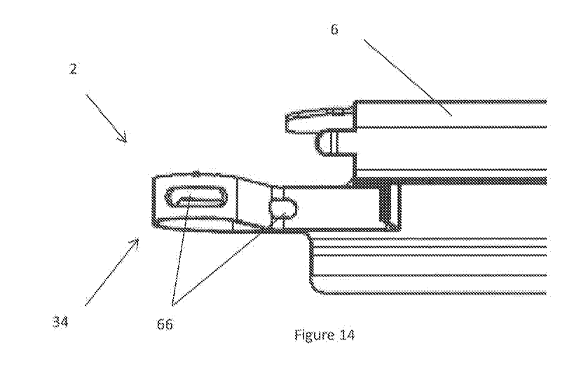

FIG. 14 illustrates a retraction clip 2 connected to a pad clip 6. The retraction clip 2 includes a deformable portions 34 having reliefs 86 that vary the amount of force created in a retraction direction.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shell include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements ingredients, components or steps.

It is understood that the above description is intended to be illustrative and restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

1. A retraction clip comprising:
a. an attachment feature and
b. a retraction feature connected to the attachment feature;
wherein the attachment feature attaches the retraction clip to a component of a brake system so that the retraction clip assists in retracting a brake pad after a brake apply.

2. The retraction clip of claim 1, wherein the component is a pad clip.

3. The retraction clip of claim 1, wherein the attachment feature includes one or more attachment arms, and the one or more attachment arms form an attachment pocket for receiving the component of the brake system.

4. The retraction clip of claim 3, wherein the attachment feature folds back upon itself forming an attachment pocket between the folds.

5. The retraction clip of claim 3, wherein the attachment feature is generally “S” shaped.

6. The retraction clip of claim 4, wherein the attachment pocket is positioned so that the component of the brake system is moved into the attachment pocket during a brake apply.

7. The retraction clip of claim 3, wherein the attachment pocket is free of any locking features.

8. The retraction clip of claim 1, wherein the attachment feature includes one or more detents that assist in fixedly connecting the retraction clip to the component of a brake system.

9. The retraction clip of claim 3, wherein the attachment pocket is configured so that the one or more attachment arms forming the attachment pocket exert a force on two opposing sides of the component of the brake system so that the retraction clip forms a connection with the component of the brake system.

10. The retraction clip of claim 1, wherein the retraction feature includes a retraction arm having a lip that contacts the brake pad, and one or more deformable portions.

11. The retraction clip of claim 10, wherein the one or more deformable portions are at least two deformable portions and the deformable portions store energy during each brake apply so that the deformable portions assist in retracting the brake pad after each of the brake applies.

12. The retraction clip of claim 1, wherein the attachment feature has a width and the retraction feature has a width and the width of the attachment feature is greater than then width of the retraction feature.

13. The retraction clip of claim 12, wherein the width of the retraction feature is X and the width of the attachment feature is 1.5× or more.

14. The retraction clip of claim 1, wherein the retraction feature includes one or more cross-over cutouts so that a retraction arm of the retraction feature can extend under, past, around, through, or a combination thereof an adjacent retraction feature.

15. The retraction clip of claim 3, wherein the one or more attachment arms are two adjacent attachment arms that are connected together by an attachment lock so that one of the two attachment arms is folded so that the two adjacent attachment arms are substantially parallel along a length forming the attachment pocket.

16. The retraction clip of 15, wherein the retraction feature includes a connection portion,
wherein the connection portion is connected on a first side to a first cross-over portion and on a second side to a second cross-over portion; and
wherein the first cross-over portion extends from a central region of the connection portion to a first edge of the connection portion so that a gap is formed proximate to the first cross-over portion and the second cross-over portion extends from the central region of the connection portion to a second edge of the connection portion so that a second gap is formed proximate to the second cross-over portion so that the retraction arm can extend through the gap, the second gap, or both.

17. The retraction clip of claim 1, wherein the retraction clip forms a sufficient angle so that a brake pad can be inserted into and removed from a brake system without removing the retraction clip.

18. A brake system comprising:
a. a support bracket having a leading portion and a trailing portion;
b. a pad clip attached to the leading portion of the support bracket;
c. a pad clip attached to the trailing portion of the support bracket;
d. two opposing brake pads extending between the leading side of the support bracket and the trailing side of the support bracket, wherein the two opposing brake pads both contact the pad clip in the leading portion and the pad clip in the trailing portion; and
e. one or more retraction clips comprising:
i. an attachment feature and
ii. a retraction feature connected to the retraction feature;
wherein the attachment feature attaches the one or more retraction clips to the leading pad clip, the trailing pad clip, or both so that the one or more retraction clips assist in retracting the two opposing brake pads after a brake apply, and
wherein the attachment feature folds back upon itself forming an attachment pocket between the folds for receiving one of the one or more pad clips.

19. The brake system of claim 18, wherein the leading pad clip, the trailing pad clip, or both include a retraction clip on an inboard side and an outboard side so that a retraction force is exerted on both of the two opposing brake pad.

20. The brake system of claim 19, wherein the attachment pocket is generally “S” shaped and is free of any attachment features, and
wherein the retraction feature includes at least two portions that fold back and forth.
